(19) United States
(12) Patent Application Publication
(10) Pub. No.: US 2007/0273593 A1
(43) Pub. Date: Nov. 29, 2007

(54) Antenna device

(75) Inventors: Masao Teshima, Kunitachi-shi (JP); Hiroshi Shimasaki, Hamura-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/798,575

(22) Filed: May 15, 2007

(30) Foreign Application Priority Data
May 26, 2006 (JP) 2006-146625

(51) Int. Cl. H01Q 1/24

(52) U.S. Cl. 343/702; 343/700 MS

(57) ABSTRACT

An antenna device includes an element part for transmitting and receiving a radio signal. A grounding part is placed to form a certain gap to the element part. A power supply part is formed in the grounding part and element part, and connected with a communication cable for supplying power. A part of the element part is bent to the communication cable.

### CROSS-REFERENCE TO RELATED APPLICATIONS

This application is based upon and claims the benefit of priority from Japanese Patent Application No. 2006-146625, filed May 26, 2006, the entire contents of which are incorporated herein by reference.

### BACKGROUND

1. Field

One embodiment of the invention relates to an antenna device, and in particular to an antenna device to be incorporated in a portable personal computer.

2. Description of the Related Art

Recently, various proposals have been made for an antenna device, such as a wireless LAN antenna. For example, Jpn. Pat. Appln. KOKAI Publication No. 2006-33069 proposes an antenna device, in which a flat plate constituting a quadrilateral element part and a flat plate constituting a grounding part are arranged at a predetermined interval, and the element part and grounding part are supplied with electric power. By appropriately setting a gap in an antenna device and lengths of each side of an element part, large bandwidth is realized in all ranges from a resonance frequency in a low-frequency range to a resonance frequency in a high-frequency range.

An antenna device like the one disclosed in the Jpn. Pat. Appln. KOKAI Publication No. 2006-33069 is incorporated in a notebook personal computer (a notebook PC), for example. In recent years, a notebook PC is demanded to be thin and compact, and it is preferable to ensure a space for incorporating a circuit, such as an antenna device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is a perspective view showing a configuration of an antenna device according to an embodiment of the invention;

FIG. 1B is a side view of the antenna device of FIG. 1A;

FIG. 2A is a view showing an example of incorporating an antenna device according to an embodiment of the invention; and

FIG. 2B is a side view of an antenna device according to an embodiment of the invention when incorporated in an LCD cabinet.

### DETAILED DESCRIPTION

Various embodiments according to the invention will be described hereinafter with reference to the accompanying drawings. In general, an antenna device according to one embodiment of the invention includes an element part configured to transmit and receive a radio signal. A grounding part is arranged to form a certain gap to the element part. A power supply part is formed in the grounding part and element part, and connected with a communication cable for supplying power. A part of the element part is bent toward the communication cable.

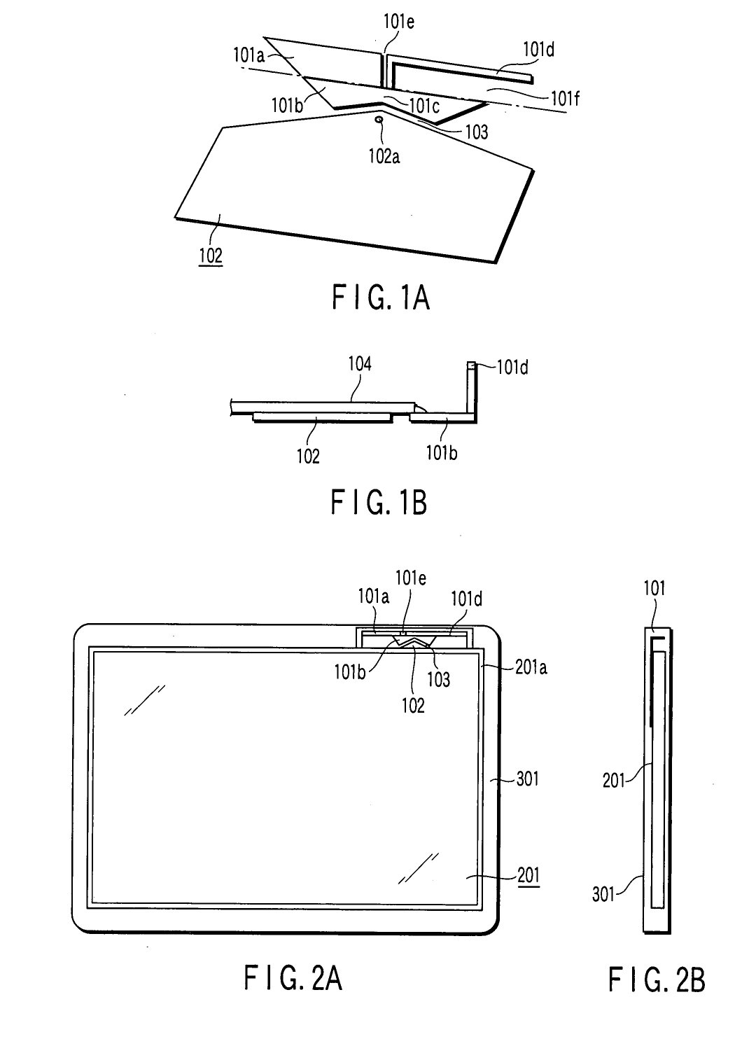

FIG. 1A is a perspective view showing a configuration of an antenna device according to an embodiment of the invention. FIG. 1B is a side view of the antenna device of FIG. 1A. The antenna device shown in FIG. 1A includes an element part 101, and a grounding part 102. The element part 101 is made of conductive material, and shaped substantially trapezoidal, for example, as shown in FIG. 1A. The element 101 includes an upper element 101a, a lower element 101b, and a low-frequency element 101d. As shown in FIG. 1B, a power supply part 101c of the lower element 101b is connected with an inner conductor (core) of a communication cable 104, such as a coaxial cable, by soldering. The method of connecting the communication cable 104 is not limited to soldering. The communication cable may be a type of cable connected to the power supply part 101c through a connector.

As shown in FIG. 1A, a slit 101e is formed between the upper element 101a and low-frequency element 101d, and a slit 101f is formed between the lower element 101b and low-frequency element 101d.

Further, as shown in FIG. 1B, the upper element 101a of the element part 101 is bent toward the communication cable 104, in the boundary to the lower element 101b (indicated by a chain line in FIG. 1A). The bending position is set so that the height of the upper element 101a becomes less than the length in the thickness direction of a housing to incorporate the antenna device.

The grounding part 102 is made of conductive material, and arranged to form a gap 103 with a certain interval to the lower element 101b of the element part 101. Here, the gap 103 is formed to be to the grounding part 102 inclined from the power supply part 101c as a peak. Thus, a notch is formed around the power supply part 101c of the element part 101, and the grounding part 102 is pentagonal (like a home plate) having two oblique sides inclined from the peripheral portion of the power supply part 102a. An outer conductor (sheath) of the communication cable 104 is soldered to the power supply part 102a of the grounding part 102.

In the antenna device configured as shown in FIGS. 1A and 1B, desired antenna characteristics can be obtained by appropriately setting the gap 103 and the shape of the element part 101 (the lengths and angles of the sides constituting the element part 101). The antenna shown in FIGS. 1A and 1B is capable of transmitting and receiving a radio signal with a frequency band different in the upper and lower elements 101a and 101b and in the low-frequency element 101d. Methods of determining the gap 103 and the shape of the element part 101 are different from the essential characteristics of this embodiment, and detailed explanation will be omitted.

In this embodiment, the antenna characteristics can be improved by forming the grounding part 102 inclined as shown in FIG. 1A.

FIG. 2A shows an example of incorporating an antenna device according to this embodiment. An explanation will be given on an example of incorporating an antenna device in a portable personal computer (e.g., a notebook PC). In FIG. 2A, an antenna device is incorporated in a housing of a liquid crystal display (LCD) provided integrally with a notebook PC, for example. A communication module in an antenna device is provided in a housing of a main body of a notebook PC, for example.

Most of the LCD housing is usually occupied by a liquid crystal panel, and the degree of flexibility in incorporating an antenna device is low. In contrast, in this embodiment, the upper element 101a of the element part 101 bent as shown in FIG. 1B is fixed just like pressing to the inner wall of the LCD housing 301. The grounding part 102 is placed in a space made between the LCD panel 201 and LCD housing 301, as shown in FIG. 2B, so that the gap 103 is exposed at an end portion 201a of the LCD panel 201.

By bending a part of the element part 101 as described above, a space sufficient for incorporating an antenna device can be ensured even in the LCD housing 301 whose degree of incorporating flexibility is low. Further, when actually incorporating an antenna device, by setting the height of the upper element 101a to lower than the thickness of the LCD housing 301, the LCD housing 301 needs not be increased in thickness for incorporating an antenna device.

Further, by placing an antenna device so that the gap 103 is exposed at the end portion 201a of the LCD panel 201, as shown in FIG. 2A, the power supply part 101c can be separated from the end portion 201a of the LCD panel 201. With this configuration, even if the end portion 201a is made of metallic materials, for example, a radio signal in the element part 101 is not disturbed by the LCD panel 201, and good antenna characteristics can be obtained. Moreover, as the gap 103 is inclined, the gap 103 can be exposed while most of the grounding part 102 is placed on the backside of the LCD panel 201.

In the examples shown in FIGS. 1A and 1B, the upper element 101a of the element part 101 is bent rectangularly. But, the upper element need not be bent rectangularly, as long as desired antenna characteristics are obtained.

While certain embodiments of the invention have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An antenna device comprising:
an element part configured to transmit and receive a radio signal;
a grounding part placed to form a certain gap to the element part; and
a power supply part which is formed in the grounding part and element part, and connected with a communication cable for supplying power,
wherein a part of the element part is bent toward the communication cable.

2. The antenna device according to claim 1, wherein when the antenna device is incorporated in a periphery of a display unit provided in a housing of a portable computer, the element part is bent so that the element part is not overlapped with an end portion of the display unit, and the gap has a certain distance to an end portion of the display unit.

3. The antenna device according to claim 2, wherein the gap is formed to be inclined from the power supply part as a peak to the grounding part.

4. The antenna device according to claim 2, wherein the grounding part is configured to be inclined from a part close to the power supply part to a part separated from the power supply part.
